(19) United States
(12) Patent Application Publication
(10) Pub. No.: US 2026/0117777 A1
(43) Pub. Date: Apr. 30, 2026

(54) Method for Monitoring the Operation of a Pump, Preferably a Centrifugal Pump

(71) Applicant: KSB SE & Co. KGaA, Frankenthal (DE)

(72) Inventors: Vincent BECKER, Erzenhausen (DE); Lucas MAURER, Frankenthal (DE); Michael SCHNEIDER, Frankenthal (DE); Sven URSCHEL, Kaiserslautern (DE)

(21) Appl. No.: 18/846,781

(22) PCT Filed: Mar. 16, 2023
(86) PCT No.: PCT/EP2023/056703

§ 371 Date: Sep. 13, 2024

(30) Foreign Application Priority Data
Mar. 16, 2022 (DE) 10 2022 106 063.2

(51) Int. Cl. F04D 15/00; F04D 15/02; F04D 29/70

(52) U.S. Cl. CPC F04D 15/0077; F04D 15/0254; F04D 29/708; F05D 2260/80

(57) ABSTRACT

A method for monitoring the operation of a centrifugal pump includes multiple steps. In one step, the method establishes whether the centrifugal pump is in a stable operating state. The centrifugal pump has a three-phase drive motor. In another step, the method monitors, when the stable operating state exists, at least one characteristic variable of the three-phase drive motor in order to establish whether there is an impeller blockage. When the impeller blockage is identified, in a further step the method activates the impeller to free-wheel. When the impeller blockage is not identified, the method also includes analyzing a frequency spectrum of a motor current to identify impairment of the centrifugal pump, and shuts down the three-phase drive motor by following a downward speed ramp if the impeller blockage is identified.

### CROSS REFERENCE TO RELATED APPLICATION

This application claims priority under 35 U.S.C. § 119 from German Patent Application No. 10 2022 106 063.2, filed Mar. 16, 2022, the entire disclosure of which is herein expressly incorporated by reference.

### BACKGROUND

The disclosure relates to a method for monitoring the operation of a pump, preferably a centrifugal pump, having a multiphase, in particular three-phase, drive motor.

Wastewater pumps, or effluent pumps, allow pumping of water that contains coarse contaminants and often carries solid constituents of different organic, inorganic or mineral origin. Wastewater pumps preferably have a single-stage design and in general are not self-priming. The impeller shapes that are used depend on the fluid being pumped. Channel impellers are often employed as the impeller, in particular in the form of a single-channel, two-channel or three-channel impeller, in each case either closed or open. However, there are also designs with an open single-channel and diagonal impeller and a vortex impeller.

The solids carried in the fluid can cause deposits to adhere to the impeller structure, which can result in impaired pump function and an associated impairment in the pump efficiency. In the worst case, the impeller can get completely blocked, with the result that no further rotation is possible. If the drive is not shut down in such a situation, this can result in mechanical damage to the pump hydraulics or can overload the electric drive motor. Against this background, it is important that the pumps, which are often operated autonomously over a long period of time, are monitored continuously, and are deactivated automatically in an emergency.

### SUMMARY

Since an emergency shutdown is a major intervention in the pump operation, however, it is desirable to be able to differentiate between acute and less acute fault situations, and to be able to take suitable countermeasures specific to each situation. Especially in the case of a fouled impeller, although the pump can continue to work, the achievable efficiency is impaired, degrading the energy performance.

An object is therefore to find measures that allow, during pump operation, differentiated identification of fault situations and initiation of fault-dependent countermeasures.

This object is achieved by a method according to the features of this disclosure. The subject matter of the disclosure also contains advantageous embodiments of the method. The object is also achieved by a pump according to the features of the disclosure, in particular a centrifugal pump, having a pump controller, and by a pump controller having the features of the disclosure.

According to the disclosure, it is first proposed for identifying a malfunction to wait initially for a stable pump operating state. A stable operating state can exist, for example, when the pump works at a constant operating point for a certain length of time. In other words, instead of the monitoring for a pump malfunction being active when the pump is first put into operation, the monitoring shall be performed only once the desired operating point is reached. If the pump identifies a stable operating state, the monitoring of at least one characteristic variable of the drive motor is started in order to be able to establish on the basis of the monitoring of this characteristic variable whether there is an impeller blockage. In the event of an impeller blockage, the pump impeller either no longer rotates, or rotates at least so sluggishly that a pumping task can no longer be usefully accomplished.

If an impeller blockage is identified, it is proposed according to the disclosure to switch the pump to free-wheel, in which the pump impeller can rotate freely. Ideally, this can be done by mechanically decoupling the pump shaft from the drive motor. It can also be provided, however, that the motor in free-wheel is disconnected from the electrical supply, and just the braking torque of the motor is applied to the pump shaft.

If there is no impeller blockage, or such a blockage is not identified, the method instead performs an analysis of the frequency spectrum of the motor current, in particular in at least one phase of the stator current. By analyzing the frequency spectrum, it is possible to identify a possible impairment in the pump operation, in particular of the pump impeller, because certain impairments, for instance imminent bearing damage or clogging or fouling of the impeller by solids deposited on the impeller, can lead to imbalance, which can cause oscillation harmonics in the motor current, or amplification of these harmonics, which can be identified reliably by means of spectral analysis.

If the spectral analysis of the motor current, in particular of at least one phase of the stator current, establishes an impairment of the pump, then the motor is slowed down to a motor speed of 0 under control by following a defined speed ramp, and deactivated. Thus an abrupt shutdown of the drive and immediate braking of the pump impeller does not take place, but instead a smooth reduction in speed is performed until the pump is at a complete standstill.

The method according to the disclosure is preferably executed in the integral microprocessor unit of the pump, in particular during the normal running time of the pump. However, execution on an external processing unit is equally conceivable and shall be included by the disclosure. The pump is preferably a centrifugal pump, in particular a pump for pumping media containing solids.

The detection of a stable operating state can be performed, for example, by observing at least one characteristic operating parameter of the pump or of the drive motor. It proves particularly advantageous to monitor an electrical variable of the drive motor, in particular of the drawn motor current. If the observed characteristic parameter remains constant or approximately constant, or is subject merely to tolerable variations, over a definable timespan, then a stable operating state of the pump is assumed, and the method begins the identification of pump impairments by means of spectral analysis.

It is conceivable, for example, that in the event of an identified impeller blockage and/or pump impairment, in particular impeller fouling, a cleaning program is initiated, during which the drive motor, in particular the pump impeller, is driven in a defined manner. Ideally, definable changes in speed and reversals in the direction of rotation are carried out cyclically in order to release impeller blockages or impeller fouling. Ideally, specific cleaning programs can be carried out according to the identified fault situation. It is conceivable, for instance, to carry out a first cleaning procedure if an impeller blockage is identified, and to carry out a second cleaning procedure if instead an impairment of the pump or impeller is ascertained. In particular, the cleaning procedures are selectively designed for the particular fault situation in order to achieve an optimum cleaning result.

The identification of an impeller blockage can be achieved, for example, by monitoring at least one characteristic operating parameter of the pump drive, in particular the drawn motor current. For example, a blockage is presumed when the observed characteristic variable exceeds a relevant limit value, or lies outside a definable interval. Ideally, an impeller blockage is assumed when the drawn motor current is greater than the rated current of the drive unit by a certain value, in particular is greater by a multiple of the rated current, for example lies above twice the rated current.

For the spectral analysis, it can be sufficient to define and monitor the spectral amplitude at at least one definable characteristic frequency. The spectral amplitude is also referred to below as the harmonic amplitude. It is conceivable, for example, that certain pump impairments lead to harmonics at specific frequencies, which are referred to below as fault frequencies.

According to an advantageous embodiment of the method, the at least one definable fault frequency is calculated as a function of the stator frequency of the drive motor and/or the number of pole pairs of the stator and/or as a function of the motor slip. The corresponding fault frequency is in particular characteristic of possible fouling of the pump impeller.

If the drive motor is a synchronous machine, the slip is omitted, and the equation for calculating the fault frequency f_{r,pump} can be defined as follows:

$${f}_{r , pump} = ( 1 \pm \frac{1}{p} ) \cdot {f}_{s} ,$$

where p represents the number of pole pairs of the stator, and fₛ is the stator frequency. For asynchronous motors, in particular induction machines, the slip s of the drive motor must also be taken into account, and the equation preferably reads as follows:

$${f}_{r , pump} = ( 1 \pm \frac{1}{p} ( 1 - s ) ) \cdot {f}_{s}$$

For the spectral analysis, the motor current/stator current measured over a timespan can be transformed into its frequency spectrum by a fast Fourier transform (FFT) or a discrete Fourier transform (DFT), in order to obtain therefrom the spectral amplitude at at least one fault frequency. The spectral analysis is preferably carried out for at least one phase of the motor current in steady state.

Since performing an FFT or DFT is very resource-hungry, the spectral amplitude of the motor current for at least one fault frequency can alternatively also be determined by a coordinate transformation. For this purpose, it is proposed to transform the multiphase, in particular three-phase, motor current into a two-axis d-q current coordinate system. The resultant current coordinate system rotates at the fault frequency of the fault-indicating harmonic, or in other words at the corresponding angular velocity. The resultant current vector in the d-q coordinate system is hence composed of a rotating current vector and a stationary current vector. The latter corresponds to the component of the motor current that lies on the harmonic, which component is constant over time in the chosen representation and hence forms a DC component of the currents i_{d} and i_{q}. In the coordinate representation, the amplitude of the fault-indicating harmonic can be determined by calculating the geometric sum of these DC components. The proposed procedure requires far fewer operations and resources than, for example, executing an FFT or DFT, and hence, because of the comparatively low resource demands, can easily be implemented on an internal microprocessor unit of a pump. Thus the solution can have a fully software-based implementation on an existing microprocessor unit for controlling a centrifugal pump. Sensors that are present anyway for measuring the motor currents can be used; any additional hardware is not required.

As has already been explained, the DC components of the currents i_{d} and i_{q}, which are determined by transformation, provide the information needed to determine the amplitude of the harmonic. A simple procedure for determining these DC components is to apply a low-pass filter, thereby filtering out the time-variable AC component of the respective currents i_{d}, i_{q}. A first-order low-pass filter ideally is used. It is particularly preferred to use a first-order Butterworth filter, the transfer function of which can be defined by

$$H ( z ) = \frac{1 - {e}^{{ω}_{c} T}}{z - {e}^{{ω}_{c} T}}$$

where T preferably equals the sampling rate of the processor unit. The cutoff frequency ω_{c} must be chosen to be relatively small in order to to remove the oscillation as far as possible.

According to an advantageous embodiment of the disclosure, the Park transform is applied for transforming the motor currents into the d-q current coordinate system, in particular given by the formula

$${\underline{\vec{l}}}_{dq} = {\underline{\vec{l}}}_{a β} \cdot {e}^{- i ( {ω}_{F} t )} ,$$

where \vec{l}_{αβ} is a space vector representation of the three-phase motor current in a stator coordinate system, and ω_{F} is the angular velocity that corresponds to the fault-indicating oscillation frequency, which angular velocity is given by ω_{F}=2ηf_{r,pump}. Trigonometric functions required for applying the Park transform can be implemented inside the microprocessor unit by look-up tables containing a defined number of value pairs, in order to minimize the memory space needed in the microprocessor unit. Using 300 to 400 value pairs, in particular 360 value pairs, is conceivable.

The aforementioned Park transform is often employed in field oriented control (FOC) of the speed of an electric motor, in which process, instead of determining the i_{q} current coordinate system on the basis of a specific frequency of a harmonic, it is determined on the basis of the instantaneous rotor speed, resulting in a coordinate system that is stationary with regard to the rotor. If this is the case, the method according to the disclosure can already make use of an existing control chip for FOC implementation in order to perform the Park transform.

Since a requirement of the Park transform is a space vector representation of the three-phase motor current, the three-phase motor current must first be translated into a two-dimensional space vector representation. This can be done by transformation into a stator coordinate system by means of a Clarke transform. Again in this case, it possible in theory to reuse an already existing FOC control chip, or instead to take just the information about the space vector representation from the control chip.

According to an advantageous embodiment, the method is carried out in particular for a wastewater pump, because impeller fouling, and associated impairments to the pump, frequently occur especially when pumping fluids containing solids. The method according to the disclosure makes it possible for wastewater pumps, which are often operated autonomously, to identify at an early stage an unwanted impairment in its pump efficiency and to take suitable measures in order to resolve associated impeller impairments automatically. In addition, a completely blocked impeller can be identified and distinguished from impeller fouling.

The present disclosure relates not only to a method but also to a pump, preferably a centrifugal pump, which in particular is designed to operate as a wastewater pump. The pump according to the disclosure has a pump controller, which is configured to perform the method according to the present disclosure. The pump accordingly has the same advantages and features as were disclosed above with reference to the method according to the disclosure. Therefore, these are not described again.

The disclosure also relates to a pump controller for use in or with a pump, in particular a centrifugal pump, particularly preferably with a wastewater pump, which controller is configured to perform the method according to the present disclosure. Said pump controller can be an integral part of a pump, for example, although it can also be implemented as an external module that has a merely communicative connection to a suitable pump unit in order to perform the method according to the disclosure. It is also conceivable that said pump controller has a connection to more than one pump unit, and monitoring, in particular parallel monitoring, of a plurality of pump units is possible.

Further advantages and features of the disclosure shall be explained below with reference to the exemplary embodiments presented in the figures, in which:

### BRIEF DESCRIPTION OF THE DRAWINGS

FIG. 1 shows a flow diagram of the method according to the disclosure;

FIG. 2 shows a diagram of the spectrum of one phase of the drawn motor current;

FIG. 3 shows a second flow diagram for illustrating the method according to the disclosure;

FIG. 4 shows the stationary stator coordinate system in relation to the rotating d-q coordinate system;

FIG. 5 shows a representation of the d-q coordinate system rotating at the fault frequency for the fault analysis; and

FIG. 6 shows a block diagram for illustrating the individual method steps for fault monitoring

### DETAILED DESCRIPTION

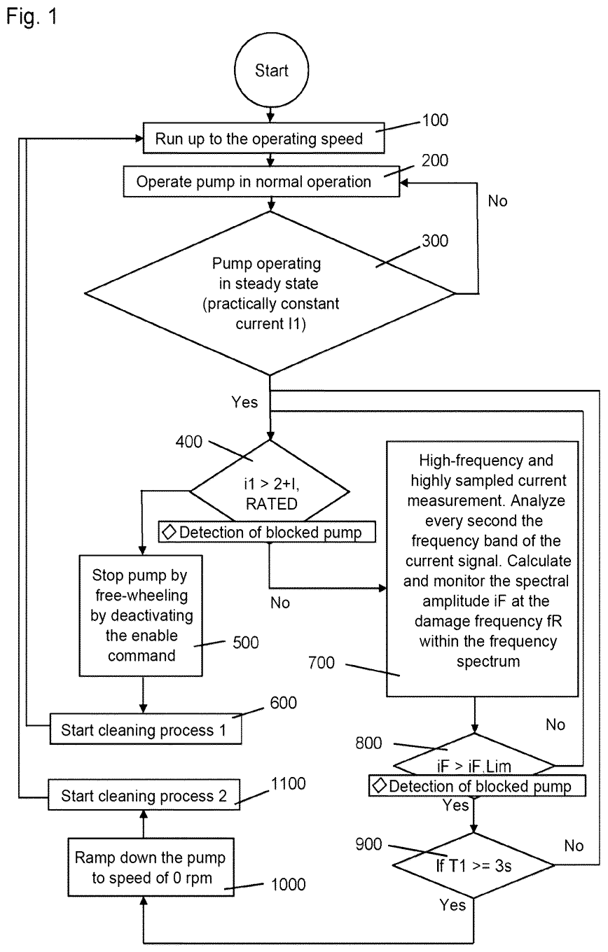

FIG. 1 shows the flow diagram of a first embodiment of the method according to the disclosure for monitoring the operation of a wastewater pump. The pump has at least one impeller, which is driven by a multiphase-fed electric motor.

When the pump is first put into operation, the pump is initially run up to the desired operating speed according to a defined speed ramp (block 100). After reaching the operating speed, the pump shifts into normal pump operation (block 200). In normal pump operation, a check is made to ascertain whether the pump is in a stable operating state (block 300). For this purpose, the motor current drawn by the motor is detected. If the motor current remains constant or nearly constant during a certain timespan, a stable operating point is presumed to exist, and the method proceeds to step 400.

In block 400, the drawn motor current in at least one phase of the drive motor is compared with a limit value, which here equals twice the rated motor current 2*I_{rated}. If the drawn motor current exceeds this limit value, a blockage of the pump impeller is inferred, and the pump controller initiates an immediate pump stop. This is done by immediately disconnecting the electrical supply from the motor and making the pump impeller free-wheel (block 500), thereby reducing the risk of the identified blockage damaging the impeller. The method then proceeds to block 600, in order to start a process for cleaning the pump that is designed specifically for an impeller blockage. The cleaning process can contain a series of changes in the direction of rotation of the impeller in order to force the blockage to release. If the cleaning process was successful, the method returns to the starting point for putting the pump into operation (block 100).

If, on the other hand, in block 400 the detected motor current remains below the limit value 2*I_{rated}, i.e. there is no impeller blockage, then instead a spectral analysis is performed on the motor current in at least one phase (block 700). This is done, for example, by a high-frequency and highly sampled current measurement and analyzing every second the frequency band of the current signal. This is used as the basis for calculating and monitoring the spectral amplitude iF at the fault frequency f_{r,pump}. In the embodiment of FIG. 1, the spectral amplitude is calculated by transforming the temporal waveform of the detected motor current into its frequency spectrum, either by the discrete Fourier transform (DFT) or by the fast Fourier transform (FFT).

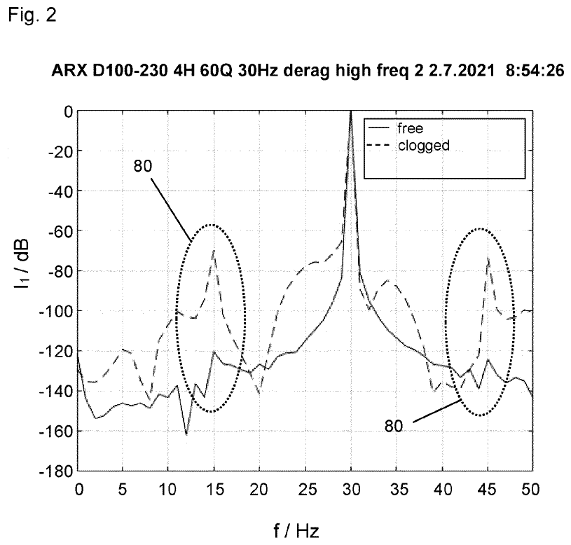

FIG. 2 shows by way of example the frequency spectrum of one phase of the drawn stator current, specifically for the fault-free case “free” and for the impeller fouling case “clogged”. The two labeled circles 80 mark the amplitudes of the sidebands of the current spectrum, which are characteristic of specific impairments in the pump function and consequently are referred to as fault or damage frequencies. Oscillation harmonics in the motor current at these frequencies can be considered as an indicator of the existence of an impairment, for example an imbalance or a mechanical misalignment in the hydraulics and also in the drive section of the pump. Said imbalance and misalignment can be produced by a clogged impeller, a bearing fault or even dry-running of the pump. It is clearly evident in this case that the spectral amplitudes at the identified damage frequencies 80 increase markedly when there is significant build-up on the impeller of the pump.

The aforementioned relevant fault frequency f_{r,pump} can be calculated using a fault model that calculates the fault frequency according to equation (1) as a function of the stator frequency (rotor speed n), the motor slip s and the number p of pole pairs of the drive motor:

$${f}_{r , pump} = ( 1 \pm \frac{1}{p} ( 1 - s ) ) \cdot {f}_{s} . \qquad ( 1 )$$

The slip s clearly has to be used only when an asynchronous machine is being used as the drive motor. If instead a synchronous machine is employed as the drive motor, a drag s=0 can be inserted into the above equation.

In block 800, The spectral amplitude iF determined for the at least one characteristic fault frequency f_{r,pump} is compared with a limit value iF, Lim. If the limit value is exceeded, the method infers an impairment of the pump impeller, in particular impeller fouling that impairs the efficiency, and initiates a shutdown of the drive unit in response. It is required here as a second precondition, however, that the limit value is exceeded for at least 3 seconds (block 900).

Unlike in the case of an impeller blockage, however, on detection of impeller fouling, an immediate shutdown of the drive motor is not initiated, but instead the pump is decelerated in a measured way along a defined speed ramp to a speed of 0 (block 1000) until the impeller comes to a standstill. Only afterwards is a second cleaning procedure (block 1100) carried out, which differs from the first cleaning procedure 600.

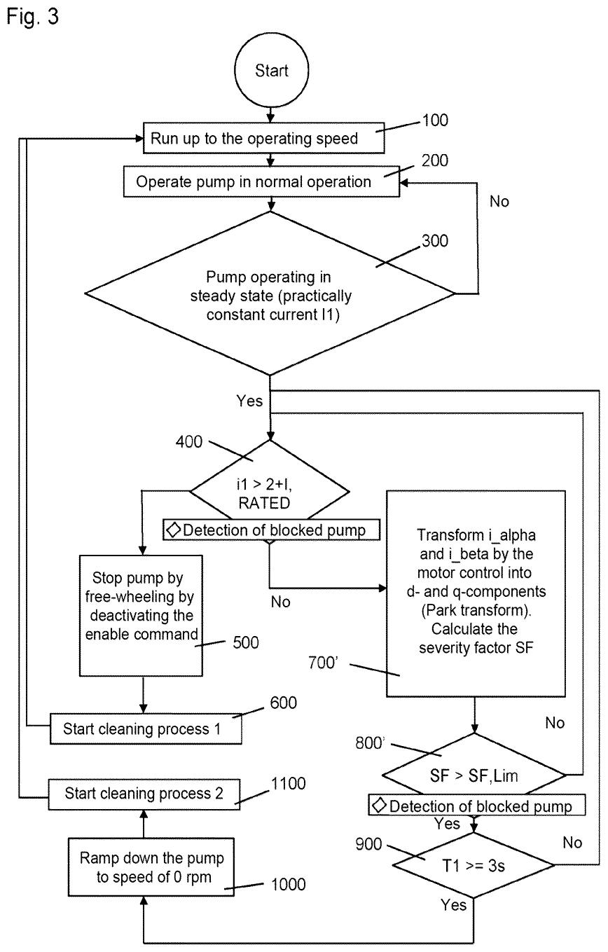

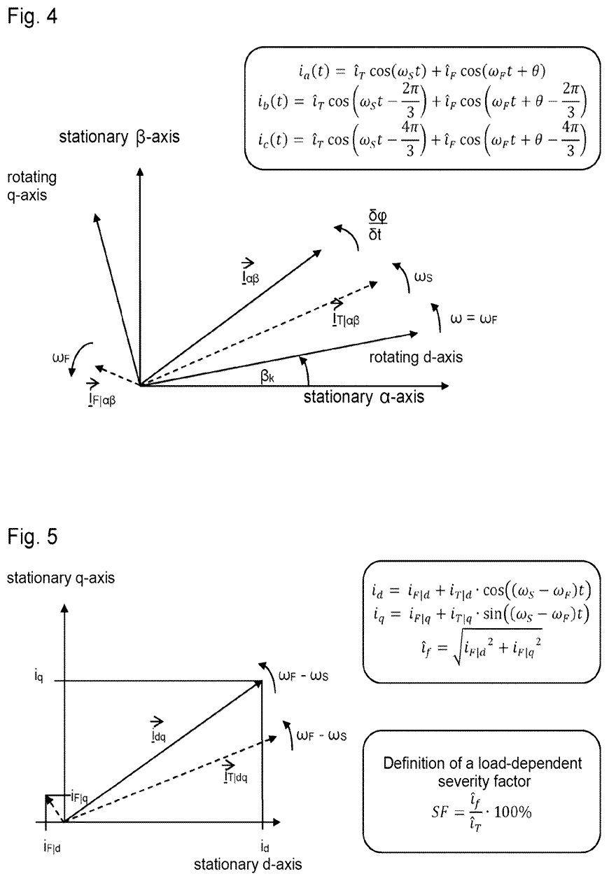

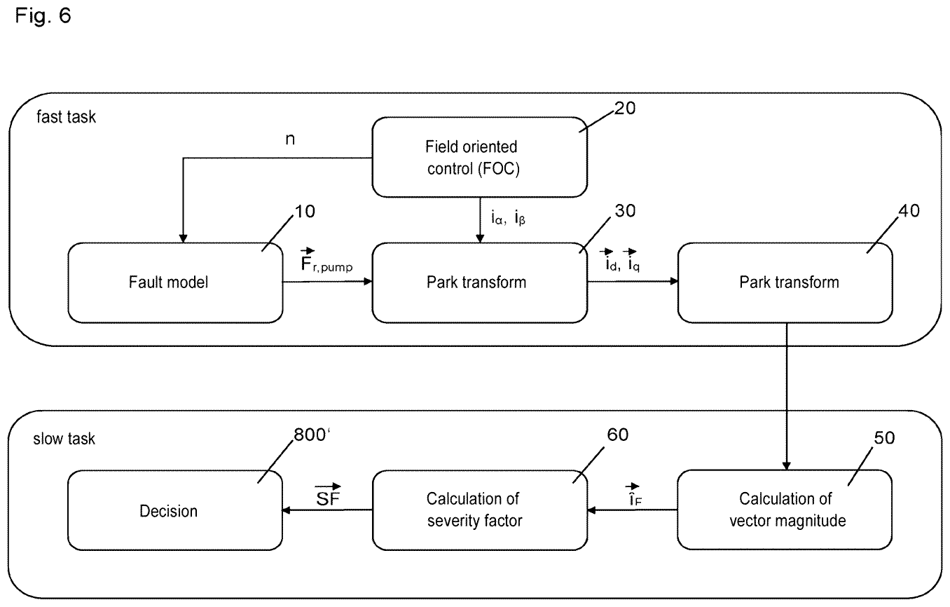

FIGS. 3-6 show a modified embodiment of the method according to the disclosure. The block diagrams in FIGS. 2 and 3 are identical except for blocks 700, 800, 700′, 800′, i.e. the spectral analysis of the motor current, and therefore the same reference signs are used for the same method steps in both figures, and the following discussion deals only with the difference in the blocks 700′, 800′. FIGS. 4 and 5 show a diagram for illustrating the procedure. FIG. 6 shows a block diagram, which describes the process in block 700′ again in detail.

For the fault monitoring at the specific frequencies of the current spectrum, the principle of the multiple reference frame theory is used instead of an implementation by means of FFT or DFT, with a view to minimizing memory usage and the number of operations. Similar to the case of field oriented control (FOC), the idea is to make a coordinate system rotate. Whereas in FOC the coordinate system rotates at the frequency of the rotor, for the purpose of fault identification it rotates at the frequency of a fault. As was already explained above, at least one fault frequency is determined using the equation given by (1). This is labeled in the diagram of FIG. 6 by the reference sign 10.

For a three-phase motor, the motor currents can be combined in a space vector. For this purpose, it is assumed that the sum of the phase currents is zero. The real part of the space vector is denoted as the α current, and the imaginary part as the β current. The α-β coordinate system (see FIG. 4) is referred to as a stator-referenced coordinate system (stator coordinate system). The transformation of the three-phase stator currents into the two-phase α-β current is called a Clarke transform.

In order to drive an AC motor, the stator-referenced α-β current is transformed by the controller into the rotor-referenced d-q current, which process is called a Park transform. From the mathematical viewpoint, a coordinate system is made to rotate at a speed equal to the speed n of the rotor. As a result, the d-q current is a DC value, which can be used for the motor control. The interesting aspect is that the vector sum of the d-current and q-current is exactly equal to the amplitude of the fundamental harmonic of the motor current. The modified embodiment of the method makes use of this principle for the fault identification.

If an actual motor is considered, then superimposed on the phase current and hence the current space vector are oscillations, the extent of which increase during faulty operation of the pump or drive motor. For the method according to the disclosure, it is now assumed that the motor current is the sum of the torque-producing current of amplitude î_{T} and speed ω_{S} and of a harmonic of amplitude î_{F} and speed ω_{F}. The motor currents of the three phases can be calculated according to the following equations (2):

$${i}_{a} ( t ) = {\hat{ι}}_{T} cos ( {ω}_{S} t ) + {\hat{ι}}_{F} cos ( {ω}_{F} t + θ ) \qquad ( 2 )$$

$${i}_{b} ( t ) = {\hat{ι}}_{T} cos ( {ω}_{S} t - \frac{2 π}{3} ) + {\hat{ι}}_{F} cos ( {ω}_{F} t + θ - \frac{2 π}{3} )$$

$${i}_{c} ( t ) = {\hat{ι}}_{T} cos ( {ω}_{S} t - \frac{4 π}{3} ) + {\hat{ι}}_{F} cos ( {ω}_{F} t + θ - \frac{4 π}{3} )$$

In this case, î_{F} contains information about the state of the pump and about the severity of the fault. As an example, ω_{F} can be calculated on the basis of equation (1).

As shown in FIG. 4, the current space vector \vec{l}_{αβ} in the stator coordinate system equals the sum of the torque-producing component \vec{l}_{T|αβ}, which rotates at the speed ω_{S}, and the fault component \vec{l}_{F|αβ}, which rotates at the speed ω_{F}. The current space vector \vec{l}_{αβ} of the three-phase motor current is calculated according to the following equation (3):

$${\underline{\vec{l}}}_{a β} = {\hat{ι}}_{T} \cdot {e}^{i ( {ω}_{S} t )} + {\hat{ι}}_{F} \cdot {e}^{i ( {ω}_{F} t + θ )} \qquad ( 3 )$$

In the block diagram shown in FIG. 6, this step is already implemented by the existing field oriented control 20 of the pump controller, which supplies as output values the two currents iₐ and i_{β}.

For the purpose of the method according to the disclosure, the length of \vec{l}_{F|αβ} is of interest. The d-q coordinate system is then rotated at the velocity of the harmonic frequency (ω_{K}=ω_{F}). The standard equation for the Park transform is used to calculate the current vector in d-q coordinates, which is labeled by step 30 in the block diagram. The Park transform can be implemented mathematically according to the following equation:

$${\underline{\vec{l}}}_{dq} = {\underline{\vec{l}}}_{a β} \cdot {e}^{- i ( {ω}_{F} t )} \qquad ( 4 )$$

Inserting equation (3) into equation (4) yields the equation (5) for the instantaneous vector \vec{l}_{dq} in the d-q coordinate system:

$${\underline{\vec{l}}}_{dq} = {\hat{ι}}_{F} \cdot {e}^{i θ} + {\hat{ι}}_{T} \cdot {e}^{i [ ( {ω}_{S} - {ω}_{F} ) t ]} \qquad ( 5 )$$

The rotating-current vector \vec{l}_{dq} is equal to the sum of the vectors \vec{l}_{T|dq}, which rotate at the velocity (ω_{S}-ω_{F}), and the stationary vector \vec{l}_{F|dq}; see FIG. 5. If ω_{F} is greater than ω_{S}, both \vec{l}_{dq} and \vec{l}_{T|dq} rotate in the other direction.

If time-dependent variables are considered, i_{d} and i_{q} consist of a DC component and an AC component, as presented in equations (6) and (7).

$${i}_{d} = {i}_{F \vert d} + {i}_{T \vert d} \cdot cos ( ( {ω}_{S} - {ω}_{F} ) t ) \qquad ( 6 )$$

$${i}_{q} = {i}_{F \vert q} + {i}_{T \vert q} \cdot sin ( ( {ω}_{S} - {ω}_{F} ) t ) \qquad ( 7 )$$

The initial amplitude î_{f} can be calculated from the geometric sum of i_{F|d} and i_{F|q}; see equation (8) below.

$${\hat{ι}}_{f} = \sqrt{{i}_{F \vert d}^{2} + {i}_{F \vert q}^{2}} \qquad ( 8 )$$

This method step is labeled by the reference sign 50 in the block diagram of FIG. 6. If the DC components of i_{d} and i_{q} are determined, the amplitude î_{f} can be calculated therefrom. Thus the amplitude of a harmonic can be calculated by applying simple transforms. A simple and memory-friendly method for calculating the DC components of i_{d} and i_{q} is a first-order filter, which is labeled by the reference sign 40 in the block diagram of FIG. 6.

For example, a first-order Butterworth filter can be chosen, the transfer function of which can be defined as follows by equation (9):

$$H ( z ) = \frac{1 - {e}^{{ω}_{c} T}}{z - {e}^{{ω}_{c} T}} , \qquad ( 9 )$$

where T is equal to the sampling interval of the microprocessor unit. The filter allows a simple implementation. The cutoff frequency ω_{c} must be chosen to be relatively small, however, in order to to remove the oscillation as far as possible. This means that the time constant of the filter is relatively high, which makes the system slow, and this can be a problem in dynamic systems, When employed in a pump, however, this is uncritical because rapid changes in load are not expected.

Then, in block 800′, as an alternative to that presented in FIG. 3, the value determined as described above for the spectral amplitude î_{f} could be compared with a limit value iF, Lim, where if this limit is exceeded for the length of time of at least 3 s (block 900), again the pump is stopped (block 1000) and then the cleaning procedure (block 1100) is initiated.

As an alternative to this variant, however, as shown in FIG. 3, in block 700′, instead of determining just the spectral amplitude î_{f}, as described above, the severity factor SF is also determined. In particular in the case of pumps that are controlled, for example pressure-controlled pumps, the load and speed of the pump can vary during operation, which at the same time also means a change in the current drawn by the pump. In order to take account of this, the severity factor (SF) for a fault is calculated, which is related to the current draw. This is labeled in the block diagram of FIG. 6 by the reference sign 60. If the motor control of the pump has FOC 20, the information about the current draw is available. To ensure load-independence, the severity factor SF is formed from the ratio of the fault-indicating spectral amplitude î_{f} and the amplitude î_{T} of the torque-producing component, which is equal to the q-current in the FOC being used, where the d-current is controlled to zero:

$$S F = \frac{{\hat{ι}}_{f}}{{\hat{ι}}_{T}} \cdot 100 \% .$$

Based on the severity factor SF, a comparison with a limit value SF, Lim can be used in block 800′ (see FIGS. 3 and 6) to decide whether or not impeller fouling is present in the pump. If this is identified, and identified for a length of time of more than 3 seconds, then the pump is slowed down to a speed of zero (block 1000), and then the cleaning procedure 2 is started (block 1100).

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

1-15. (canceled)

16. A method for monitoring the operation of a centrifugal pump, the method comprising:
establishing whether the centrifugal pump is in a stable operating state, wherein the centrifugal pump has a three-phase drive motor;
when the stable operating state exists, monitoring at least one characteristic variable of the three-phase drive motor in order to establish whether there is an impeller blockage;
when the impeller blockage is identified, activating the impeller to free-wheel; and
when the impeller blockage is not identified, analyzing a frequency spectrum of a motor current to identify impairment of the centrifugal pump, and shutting down the three-phase drive motor by following a downward speed ramp if the impeller blockage is identified.

17. The method as claimed in claim 16, wherein the impairment of the centrifugal pump involves an impairment of the impeller, or impeller fouling.

18. The method as claimed in claim 17, further comprising: initiating a cleaning program on identification of the impeller blockage and/or identification of the impeller fouling.

19. The method as claimed in claim 18, further comprising: performing a first cleaning program, after identifying the impeller blockage, and performing a second cleaning program after identifying the impeller fouling.

20. The method as claimed in claim 19, wherein the impeller blockage is identified by monitoring a drawn motor current, and the impeller blockage is identified when the drawn motor current lies above a multiple of a rated current.

21. The method as claimed in claim 20, wherein the analyzing the frequency spectrum comprises monitoring a spectral amplitude of the motor current at least at one fault frequency.

22. The method as claimed in claim 21, wherein the at least one fault frequency is determined as a function of pole pairs of the stator and/or a stator frequency and/or a motor slip, as given by
$${f}_{r , pump} = ( 1 \pm \frac{1}{p} ( 1 - s ) ) \cdot {f}_{s}$$
for an induction motor, and for a synchronous motor as given by
$${f}_{r , pump} = ( 1 \pm \frac{1}{p} ) \cdot {f}_{s} ,$$
where p is the number of pole pairs of the stator, s is the motor slip, and fₛ is the stator frequency.

23. The method as claimed in claim 22, wherein the spectral amplitude is monitored by the fast Fourier transform or by a discrete Fourier transform.

24. The method as claimed in claim 22, wherein spectral amplitude î_{f} of the motor current for the at least one determined fault frequency f_{r,pump} is calculated by transforming the three-phase motor current into a d/q current coordinate system rotating at the fault frequency f_{r,pump} and containing the currents i_{d} and i_{q}, where a geometric sum of the DC components of the currents i_{d} and i_{q} in the d-/q current coordinate system equals the spectral amplitude î_{f}.

25. The method as claimed in claim 24, wherein DC components of the transformed currents i_{d} and i_{q} is determined by applying a a first-order Butterworth filter.

26. The method as claimed in claim 25, wherein the transformation into the d-q current coordinate system is performed by a Park transform, given by
$${\underline{\vec{l}}}_{dq} = {\underline{\vec{l}}}_{a β} \cdot {e}^{- i ( {ω}_{F} t )} ,$$
where \vec{l}_{αβ} is a space vector representation of the three-phase motor current in a stator coordinate system, and an angular velocity ω_{F} is calculated from the fault frequency f_{r,pump} in accordance with ω_{F}=2πf_{r,pump}.

27. The method as claimed in claim 26, wherein the transformation of the three-phase motor current into the space vector representation in the stator coordinate system is performed by a Clark transform, where the space vector \vec{l}_{αβ} is determined preferably by an existing control chip of the pump controller, wherein the control chip performs field oriented speed control.

28. The method as claimed in claim 27, wherein the centrifugal pump is a wastewater pump.

29. A centrifugal pump, for operation as a wastewater pump, having a pump controller which is configured to perform the method as claimed in claim 28.

30. A pump controller for a centrifugal pump, which is configured to implement the method as claimed in claim 28.
